(19) United States
(12) Patent Application Publication
(10) Pub. No.: US 2026/0338823 A1
(43) Pub. Date: Oct. 29, 2026

(54) ACCELEROMETER

(71) Applicants: DENSO CORPORATION, Kariya-shi (JP); TOYOTA JIDOSHA KABUSHIKI KAISHA, Toyota-shi (JP); MIRISE Technologies Corporation, Nisshin-shi (JP)

(72) Inventors: Hideaki NISHIKAWA, Nisshin-shi (JP); Yusuke KAWAI, Nisshin-shi (JP); Akira WADA, Nisshin-shi (JP)

(21) Appl. No.: 19/573,459

(22) Filed: Mar. 20, 2026

(30) Foreign Application Priority Data
Apr. 24, 2025 (JP) 2025-072567

(51) Int. Cl. G01P 15/125

(52) U.S. Cl. CPC G01P 15/125

(57) ABSTRACT

An accelerometer includes a substrate and a frame-shaped inertial body that is suspended relative to the substrate. A first anchor is fixed to the substrate and is located within a region surrounded by the inertial body. A set of torsion springs, which is suspended relative to the substrate, connect the inertial body to the first anchor. A second anchor is fixed to the substrate at a position different from the first anchor. A leaf spring, which is suspended relative to the substrate, extends along the outer contour of the inertial body in a direction orthogonal to the torsion springs and connects the second anchor to the inertial body. The torsion springs are located on a common straight line, the leaf spring’s center is on this line, and the inertial body’s center of gravity is offset from the torsion springs.

### CROSS REFERENCE TO RELATED APPLICATION

This application is based on Japanese Patent Application No. 2025-072567 filed on Apr. 24, 2025, the disclosure of which is incorporated herein by reference.

### TECHNICAL FIELD

The present disclosure relates to an accelerometer.

### BACKGROUND

An accelerometer may include a torsion spring, an anchor, an inertial body, and a detection electrode that are disposed on a substrate. The accelerometer may include: an inertial body that is held in a suspended state relative to a substrate and is displaced in each of x-, y-, and z-directions when acceleration is applied from outside; an anchor that is connected to the semiconductor substrate; and a torsion spring that connects the inertial body to the anchor.

### SUMMARY

According to an aspect of the present disclosure, an accelerometer includes a substrate, an inertial body, at least one first anchor, at least one set of torsion springs, at least one second anchor, and at least one leaf spring. The inertial body includes a frame shape and is suspended relative to the substrate. At least one first anchor is fixed to the substrate, and is located within a region of the substrate surrounded by the inertial body. At least one set of torsion springs is suspended relative to the substrate, and connect the inertial body to at least one first anchor. At least one second anchor is fixed to the substrate, and is located at a position on the substrate different from a position of the first anchor. At least one leaf spring is suspended relative to the substrate, and extend along an outer contour of the inertial body and extend in an extending direction orthogonal to at least one set of torsion springs. At least one leaf spring connects at least one second anchor to the inertial body. At least one set of torsion springs may be located on a common straight line, and the straight line is an imaginary line. A center of at least one leaf spring in the extending direction may be located on the common straight line. A center of gravity of the inertial body may be offset with respect to positions of one set of torsion springs.

### BRIEF DESCRIPTION OF DRAWINGS

FIG. 1 is a plan view of an accelerometer according to a first embodiment.

FIG. 2 is an arrow view as seen from direction II in FIG. 1.

FIG. 3 is a cross-sectional view taken along line III-III in FIG. 1.

FIG. 4 is a cross-sectional view taken along line IV-IV in FIG. 1.

FIG. 5 is a view corresponding to FIG. 2, and illustrates a displacement of a leaf spring and an inertial body caused by the application of acceleration in a z-direction.

FIG. 6 is a plan view of an accelerometer according to a second embodiment.

FIG. 7 is a plan view of an accelerometer according to a third embodiment.

FIG. 8 is a plan view of a modified example of the accelerometer according to the third embodiment.

FIG. 9 is a plan view of an accelerometer according to another embodiment.

### DETAILED DESCRIPTION

In a comparative accelerometer, when a torsion spring bends, an inertial body may be displaced in the x-direction. When the torsion spring extends or contracts, the inertial body may be displaced in the y-direction. When the torsion spring twists, the inertial body may be displaced in the z-direction. A change in capacitance accompanying the displacement of the inertial body may be detected by a detection electrode. This accelerometer may detect acceleration in three directions by allowing the inertial body to be displaced in the x-, y-, and z-directions and detect the change in the capacitance that occurs during these displacements.

The torsion spring may deform linearly in proportion to the magnitude of the applied acceleration in one of the x-, y-, and z-directions. On the other hand, when the torsion spring is subjected to acceleration in multiple directions simultaneously, two or more types of deformation—such as bending, stretching/compression, and torsion—may occur, resulting in nonlinear deformation. In the above accelerometer, when the torsion spring deforms nonlinearly, changes in capacitance—namely, the output signal corresponding to the applied acceleration—may be affected by noise, resulting in possible errors. Furthermore, when the torsion spring undergoes nonlinear deformation, it may be difficult to reduce noise by performing computational correction of the output signal from the detection electrode using an electronic circuit.

According to an aspect of the present disclosure, an accelerometer includes a substrate, an inertial body, at least one first anchor, at least one set of torsion springs, at least one second anchor, and at least one leaf spring. The inertial body includes a frame shape and is suspended relative to the substrate. At least one first anchor is fixed to the substrate, and is located within a region of the substrate surrounded by the inertial body. At least one set of torsion springs are suspended relative to the substrate, and connect the inertial body to at least one first anchor. At least one second anchor is fixed to the substrate, and is located at a position on the substrate different from a position of the first anchor. At least one leaf spring is suspended relative to the substrate, and extend along an outer contour of the inertial body and extend in an extending direction orthogonal to at least one set of torsion springs. At least one leaf spring connects at least one second anchor to the inertial body. At least one set of torsion springs are located on a common straight line, and the straight line is an imaginary line. A center of at least one leaf spring in the extending direction is located on the common straight line. A center of gravity of the inertial body is offset with respect to positions of one set of torsion springs.

This accelerometer has a structure in which, in addition to the leaf spring that is orthogonal to the torsion spring and the first anchor that is connected to the inertial body via the torsion spring, the second anchor is provided, and the second anchor is connected to the leaf spring. Furthermore, the inertial body has its center of gravity offset with respect to the position of the pair of torsion springs. When acceleration is applied in the x- and y-directions, the acceleration sensor suppresses displacement of the inertial body without allowing displacement of the leaf spring, whereas when acceleration is applied in the z-direction, the leaf spring can displace, permitting rotation of the inertial body. As a result, this accelerometer selectively causes displacement of the inertial body in response to acceleration in the z-direction, and suppresses nonlinear displacement of the torsion springs, thereby enabling low-noise detection of acceleration in the z-direction.

Hereinafter, embodiments of the present disclosure will be described with reference to the drawings. In the following embodiments, parts that are identical or equivalent to each other are denoted by the same reference numerals. Furthermore, in the embodiments, when only a part of a component is described, the other parts of the component may be implemented by applying the components described in the preceding embodiments. In the following embodiments, the embodiments can be partially combined with each other as long as the combination is not particularly hindered, even when not particularly specified.

### First Embodiment

The following describes an accelerometer 1 according to a first embodiment. In the present disclosure, the “accelerometer” may also be referred to as an acceleration sensor. The accelerometer 1 outputs a signal corresponding to acceleration applied in a direction orthogonal to a plane on which the accelerometer 1 mounts, and does not output a signal when acceleration is applied in other directions.

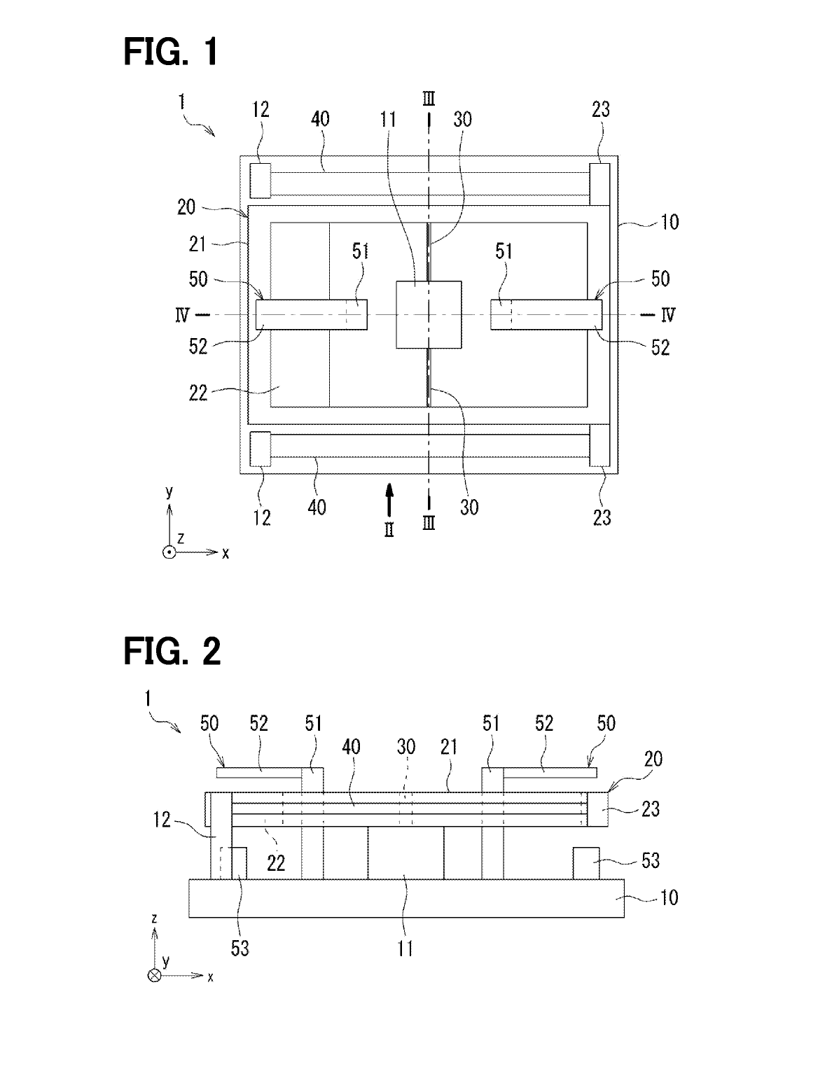

The accelerometer 1 in the present embodiment includes, for example as shown in FIG. 1, a substrate 10, a first anchor 11, a second anchor 12, an inertial body 20, a torsion spring 30, a leaf spring 40, and a detection electrode 50. The first anchor 11, the second anchor 12, the inertial body 20, the torsion spring 30, the leaf spring 40, and the detection electrode 50 are located on the substrate 10. The accelerometer 1 detects acceleration in the z-direction by: selectively displacing the inertial body 20 when acceleration in the z-direction is applied; and detecting a capacitance of a capacitor formed between the detection electrode 50 and the inertial body 20. The substrate 10 may also referred to as a board.

Hereinafter, as shown by arrows in FIG. 1, an axis along a left-right direction of the drawing among the two axes orthogonal to the plane of the substrate 10 will be referred to as the “x-direction,” and an axis along an up-down direction of the drawing will be referred to as the “y-direction,” respectively. In addition, a direction orthogonal to the plane defined by the x-direction and y-direction is referred to as the “z-direction,” and viewing the accelerometer 1 from the z-direction is referred to as a “top view.” In FIG. 1, the boundary between a fixed portion 51 and a suspended portion 52 of the detection electrode 50 is shown with a dashed line. The same applies to FIGS. 6-8.

The substrate 10 is made of a semiconductor material such as silicon, for example, and has a rectangular plate shape. The accelerometer 1 is formed, for example, by creating a sacrificial silicon oxide film on the substrate 10, epitaxially growing a polysilicon layer, patterning it using photolithography and etching methods, and then removing a portion of the sacrificial layer, thereby forming a sensor structure in a suspended state. The accelerometer 1 has a sensor structure in a suspended state by repeatedly forming a sacrificial layer, depositing a semiconductor layer, patterning the semiconductor layer, and removing unnecessary portions of the sacrificial layer multiple times.

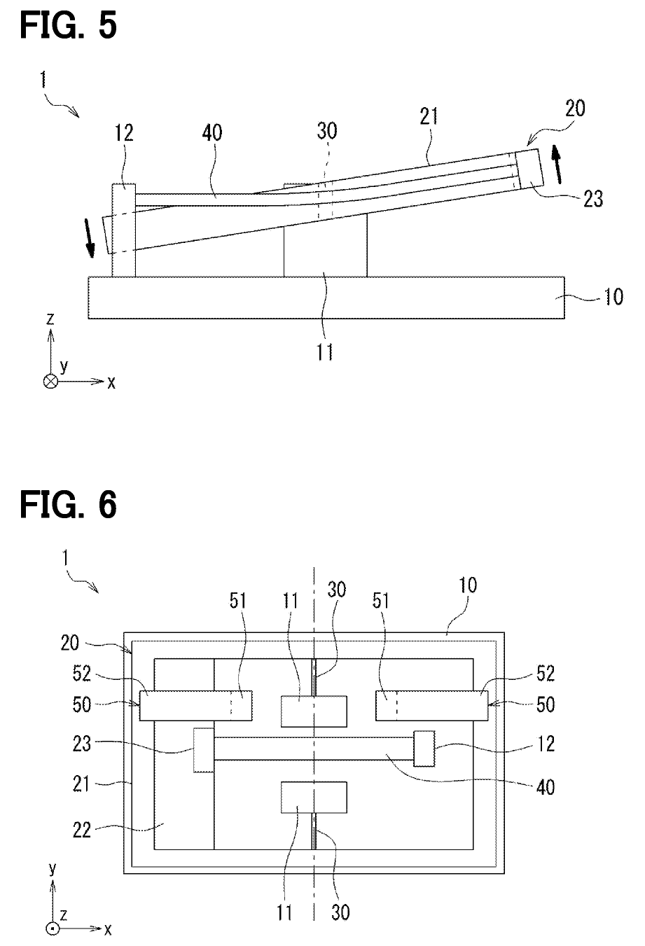

The first anchor 11 and the second anchor 12, as shown for example in FIG. 2, are fixed portions that are secured to the substrate 10 via a buried oxide film (not shown), with at least a part of their rear surfaces being fixed to the substrate 10, without being released from the substrate 10. In the present embodiment, the first anchor 11 is provided approximately at the center of the region surrounded by a frame portion 21 of the inertial body 20 on the substrate 10, and two torsion springs 30 are connected to the first anchor 11. In FIG. 2, among the components of the accelerometer 1, parts of the outlines of hidden portions—as viewed from the illustrated angle—are indicated by dashed lines. The same applies to FIG. 5.

In the present embodiment, two second anchors 12 are provided in regions of the substrate 10 that are outside the inertial body 20. The second anchors 12 are each disposed on opposite sides of the inertial body 20 in the y-direction, with a different leaf spring 40 connected to each anchor. Each of the two second anchors 12 is disposed near one end of the frame portion 21 in the x-direction.

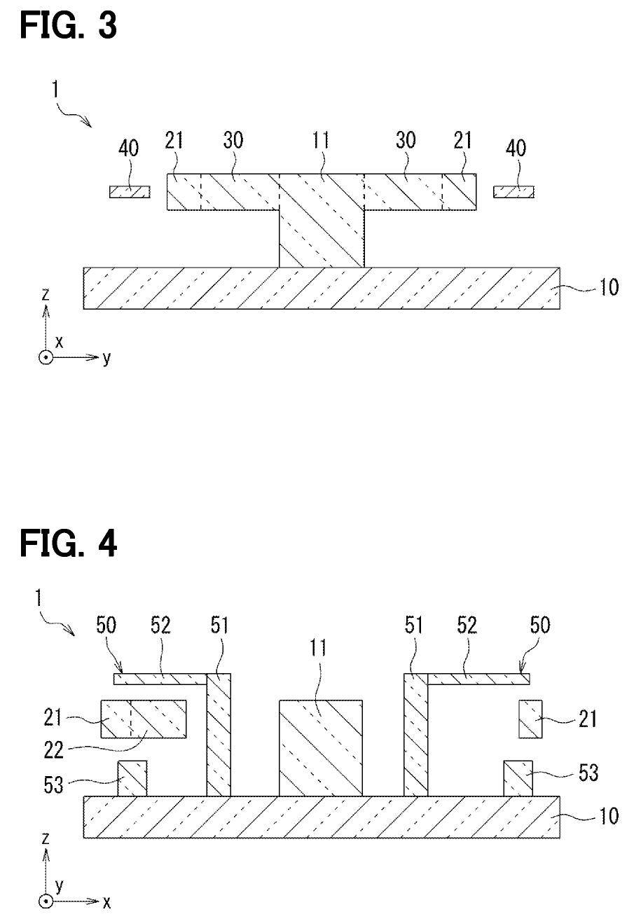

The inertial body 20, for example, includes a frame portion 21, a mass portion 22, and a connecting portion 23. As shown in FIGS. 2-4, the inertial body 20 is a region released from the substrate 10 and is suspended relative to the substrate 10. The inertial body 20 is displaceable so as to rotate about the first anchor 11 when an acceleration in the z-direction is applied to the accelerometer 1, as shown in FIG. 5. In FIGS. 3 and 4, the boundaries between adjacent components are conveniently indicated by dashed lines for clarity.

The frame portion 21 has, for example, a rectangular frame shape in a top view. The frame portion 21 has, for example, the torsion spring 30 connected to the center of each of the two sides extending along the x-direction, and is supported by the first anchor 11 via the torsion springs 30. In a top view, the frame portion 21 is arranged so that the first anchor 11 is positioned at the center of the inner opening.

The mass portion 22 is provided, for example, on the inside of the frame portion 21, at one end in the x-direction. The mass portion 22 is integrated with the frame portion 21 and is provided so that, in the x-direction, the position of the center of gravity of the inertial body 20 is displaced—i.e., offset—with respect to the position of the torsion spring 30. In the example of FIG. 1, the mass portion 22 is provided at the left end, in the x-direction, of the inside of the frame portion 21 relative to the first anchor 11, so that the mass of the left half of the inertial body 20 in the x-direction is greater than the mass of the right half in the x-direction. As a result, when an acceleration in the z-direction is applied, a moment that twists the torsion spring 30 is generated in the inertial body 20, causing the inertial body 20 to rotate about the first anchor 11.

In the present embodiment, for example, one connecting portion 23 is provided on each of the outer sides in the y-direction of the frame portion 21, forming protrusions that extend from the frame portion 21. The connecting portion 23 is provided at the end of the frame portion 21 in the x-direction, on the side opposite to the second anchor 12. Each of the two connecting portions 23 is connected to a different leaf spring 40, and the inertial body 20 is connected to different second anchors 12 via the respective leaf springs 40.

The torsion spring 30 connects the first anchor 11 to the inertial body 20, and undergoes a twisting deformation when an acceleration in the z-direction is applied, thereby allowing displacement of the inertial body 20 in the z-direction. The torsion spring 30 is connected to the first anchor 11 at two points and is arranged so that its position is aligned in the x-direction. The two torsion springs 30, for example, extend along the y-direction and are arranged on a common straight line when viewed from above, forming a pair of torsion springs 30. The two torsion springs 30 are connected, for example, at the center positions in the x-direction on the two sides of the frame portion 21 that extend along the x-direction. The common straight line mentioned above is an imaginary line. The two torsion springs 30 are configured so that their width dimension in the x-direction is smaller than their thickness dimension in the z-direction, resulting in high rigidity in the z-direction and low rigidity in the x-direction. As a result, since the z-direction corresponds to the shear direction of the torsion spring 30, the inertial body 20 does not move in the z-direction, but is configured to be rotatable in the z-direction by the torsion of the torsion spring 30.

The leaf spring 40 extends in a direction orthogonal to the two torsion springs 30, and connects the second anchor 12 to the connecting portion 23. The leaf spring 40, together with the second anchor 12 and the connecting portion 23, serves to limit the displacement direction of the inertial body 20. In the present embodiment, the leaf springs 40 are each disposed at both ends in the y-direction, with the inertial body 20 positioned between them. The two leaf springs 40 are arranged such that, in their undeformed flat state, the center of the leaf springs 40 in the longitudinal direction are located on the common straight line formed by the two torsion springs 30. In other words, the center of the undeformed leaf spring 40 in the x-direction aligns with the position of the torsion spring 30.

For example, the two leaf springs 40 are made as thin, rectangular plates, with a width in the y-direction that is at least a predetermined value, and a thickness in the z-direction that is no more than a predetermined value. That is, because the x-direction is aligned with the extension/contraction direction of the leaf springs 40, and the y-direction is aligned with their shear direction, the rigidity in both the x- and y-directions is high, thereby suppressing deformation in these directions. Furthermore, the two leaf springs 40 exhibit low rigidity in the z-direction, allowing them to be deformed into an arc shape as illustrated in FIG. 5.

With the above configuration of the torsion spring 30 and the leaf springs 40, the inertial body 20 does not move in the x-, y-, or z-directions; however, as shown in FIG. 5, the inertial body 20 is capable of rotating in the direction in which the torsion spring 30 twists. In other words, the inertial body 20 does not displace when acceleration is applied in the x- or y-directions, but rotates when acceleration is applied in the z-direction.

As shown, for example, in FIG. 2, the detection electrode 50 includes a fixed portion 51, a suspended portion 52, and a substrate electrode 53, and detects the capacitance of a capacitor formed between a part of the detection electrode 50 and the facing portion of the inertial body 20. The facing portion of the inertial body 20 faces the part of the detection electrode 50. The detection electrode 50, which is connected to wiring or wires (not shown), is configured to output a signal corresponding to the applied acceleration in accordance with the displacement of the inertial body 20. For example, one detection electrode 50 is installed on either side of the first anchor 11 along the x-direction, and, in a top view, the electrodes are arranged symmetrically with respect to the first anchor 11.

The fixed portion 51 is fixed to the substrate 10 by a buried oxide film (not shown), in the same manner as the first anchor 11. For example, the fixed portion 51 is spaced apart from the first anchor 11 and the inertial body 20, and is disposed in a region of the substrate 10 that is surrounded by the frame portion 21 and the mass portion 22. For example, the fixed portion 51 is positioned at the same location as the first anchor 11 in the y-direction. The fixed portion 51 is made to have a greater height than the first anchor 11 and the inertial body 20 in the z-direction.

For example, the suspended portion 52 is provided to extend from the distal end or the vicinity of the fixed portion 51 in a direction perpendicular to the torsion spring 30. Similar to the inertial body 20, the suspended portion 52 is formed as a suspended structure, and as shown in FIGS. 1 and 2, a predetermined region extending from its tip is disposed to face, in the z-direction, a portion of the frame portion 21. In a top view, the suspended portion 52 is of a length that does not extend beyond the outer edge of the frame portion 21. The suspended portion 52 forms a capacitor with the facing part of the frame portion 21 and is used for detecting capacitance.

The substrate electrode 53 is fixed to the substrate 10 by an embedded oxide film (not shown), in the same way as the first anchor 11. The substrate electrode 53 is disposed, for example, directly beneath the frame portion 21 of the substrate 10. The substrate electrode 53 is connected, for example, to wiring (not shown) provided on the substrate 10, and, similar to the suspended portion 52, forms a capacitor together with the facing part of the frame portion 21, being used for capacitance detection.

The above describes the configuration of the accelerometer 1 according to the present embodiment.

According to the present embodiment, the accelerometer 1 includes the leaf spring 40 that extends in a direction orthogonal to the torsion spring 30, and the inertial body 20 is fixed to the second anchor 12 via the connecting portion 23 and the leaf spring 40. Since the accelerometer 1 has a structure in which the torsion spring 30 undergoes torsional deformation among bending, stretching/compression, and torsion, while other deformations are suppressed, the displacement of the inertial body 20 is restrained when accelerations are applied in the x- and y-directions. When the acceleration is applied in the z-direction, the torsion spring 30 is twisted, causing the inertial body 20 to rotate in the z-direction, and since nonlinear deformation of the torsion spring 30 is suppressed, it is possible to detect acceleration in the z-direction with low noise.

### Second Embodiment

The following describes an accelerometer 1 according to a second embodiment. The accelerometer 1 according to the present embodiment differs from the first embodiment described above in that, for example as shown in FIG. 6, the arrangement of the second anchor 12, the connecting portion 23, the leaf spring 40, and the detection electrode 50 is changed. The following describes the difference between the present embodiment and the first embodiment. In FIG. 6, a common straight line formed by the pair of torsion springs 30 is indicated by a dashed-and-dotted line.

In the present embodiment, for example, two first anchors 11 are disposed in the inner region of the substrate 10 surrounded by the inertial body 20 (hereinafter referred to as the “inner region”), and each is connected to a different torsion spring 30. The two first anchors 11 are arranged at a distance from each other in the inner region, with at least a part of each anchor positioned on the straight line defined by the pair of torsion springs 30. In other words, the two first anchors 11 are arranged on the same straight line together with the pair of torsion springs 30. The two first anchors 11 are spaced apart by a predetermined distance or more so that at least one leaf spring 40 can be arranged in the gap between them.

In the present embodiment, for example, one second anchor 12 is disposed in the inner region of the substrate 10 as viewed from above. The second anchor 12 is arranged, for example, at a position different from the first anchor 11 in the x-direction, and its position is adjusted so that the center of the leaf spring 40 in the x-direction aligns with the position of the torsion spring 30. For example, the second anchor 12 is disposed at a position that serves as the center of the inertial body 20 in the y-direction.

In the present embodiment, the connecting portion 23 is provided on the mass portion 22 and faces the second anchor 12 in the x-direction. For example, the connecting portion 23 is provided at a position that serves as the center of the inertial body 20 in the y-direction, similarly to the second anchor 12.

In the present embodiment, the leaf spring 40, as viewed from above, connects the connecting portion 23 and the second anchor 12, and is extended so as to pass between the two first anchors 11. Similar to the first embodiment described above, the leaf spring 40 is arranged so as to be orthogonal to the pair of torsion springs 30, and is configured such that the center in its longitudinal direction—that is, the center in the x-direction—in the undeformed flat state is positioned on the straight line defined by the pair of torsion springs 30. As a result, in this embodiment as well, the leaf spring 40 exhibits high rigidity in the x- and y-directions of the accelerometer 1 and does not displace in these two directions, while having low rigidity in the z direction, allowing it to be displaced in an arc shape.

In the present embodiment, the detection electrode 50 is arranged so that its position in the y-direction is offset from the center of the inertial body 20, in order to avoid interference with the connecting portion 23 and the leaf spring 40.

According to the present embodiment, the accelerometer 1 is capable of achieving the same effects as those of the first embodiment. Furthermore, since the second anchor 12 and the leaf spring 40 of the accelerometer 1 are disposed in the inner region of the substrate 10, there is also an effect of enabling the overall miniaturization of the sensor.

### Third Embodiment

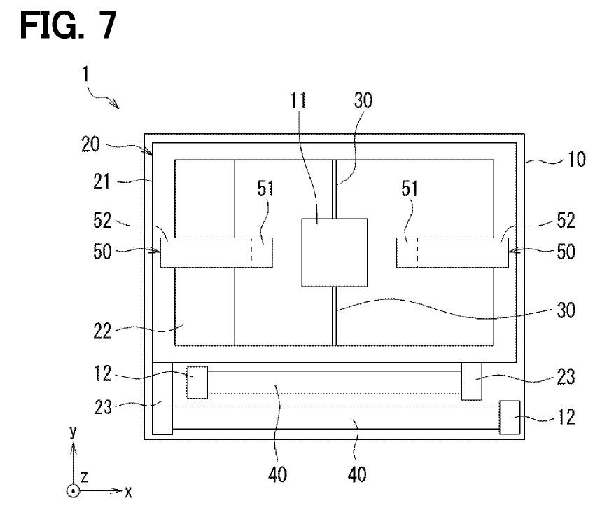

The following describes an accelerometer 1 according to a third embodiment. The accelerometer 1 according to the present embodiment differs from the first embodiment in that, as shown for example in FIG. 7, the arrangement of the second anchor 12, the connecting portion 23, and the leaf spring 40 is changed. The following describes the difference between the present embodiment and the first embodiment.

The accelerometer 1, like the first embodiment described above, includes two sets of second anchors 12, connecting portions 23, and leaf springs 40. In the present embodiment, the two sets of second anchors 12, connecting portions 23, and leaf springs 40 are arranged only on one side of the inertial body 20 in the y-direction. In FIG. 7, an example is shown in which the two sets of the second anchors 12, the connecting portions 23, and the leaf springs 40 are arranged on the lower side of the inertial body 20 in the y-direction; however, they may also be arranged on the upper side in the y-direction.

The two second anchors 12 are each disposed, for example, near both ends of the frame portion 21 in the x-direction, with each anchor connected to a different leaf spring 40. The two second anchors 12 are arranged at offset positions in the y-direction so that the two leaf springs 40 do not interfere with each other.

The two connecting portions 23 are each disposed, for example as shown in FIG. 7, near both ends of the frame portion 21 in the x-direction, and extend along the lower side in the y-direction. The two connecting portions 23 each have different lengths in the y-direction, and each is connected to a different leaf spring 40 and second anchor 12.

The two leaf springs 40 are positioned at different locations in the y-direction, and are connected to different second anchors 12 and connecting portions 23, respectively. In this embodiment, for example, the two leaf springs 40 have different lengths in the x-direction: the one closer to the inertial body 20 has a shorter length in the x-direction, while the one farther from the inertial body 20 has a longer length in the x-direction. Both of the two leaf springs 40, as in the first embodiment, are arranged orthogonally to the torsion spring 30, with their centers in the x-direction positioned on the straight line defined by the torsion spring 30. Furthermore, the position of the center of each leaf spring in the x-direction coincides with the position of the rotational center of the inertial body 20 in the x-direction.

In the present embodiment, for example, when the acceleration in the z-direction is applied, the accelerometer 1 causes the leaf spring 40 that is farther from the inertial body 20, out of the two leaf springs 40, to deform in an arc shape in response to the displacement in the z-direction of the left half of the inertial body 20 in the x-direction. Additionally, in the accelerometer 1, for example, when the acceleration in the z-direction is applied, the leaf spring 40 that is closer to the inertial body 20, out of the two leaf springs 40, is configured to deform in an arc shape in response to the displacement in the z-direction of the right half of the inertial body 20 in the x-direction.

It should be noted that, in the present embodiment, the accelerometer 1 may be configured such that one of the leaf springs 40 deforms in an arc shape in response to z-direction displacement on the left side of the inertial body 20 in the x-direction, and the other leaf spring 40 deforms in an arc shape in response to z-direction displacement on the right side in the x-direction. However, it is not limited to the above example. For example, the arrangement and dimensions of the two sets of the second anchors 12, the connecting portions 23, and the leaf springs 40 are not limited to the examples described above and may be modified as appropriate.

With the present embodiment as well, the accelerometer 1 can also achieve the same effects as the first embodiment described above.

### Modified Example of Third Embodiment

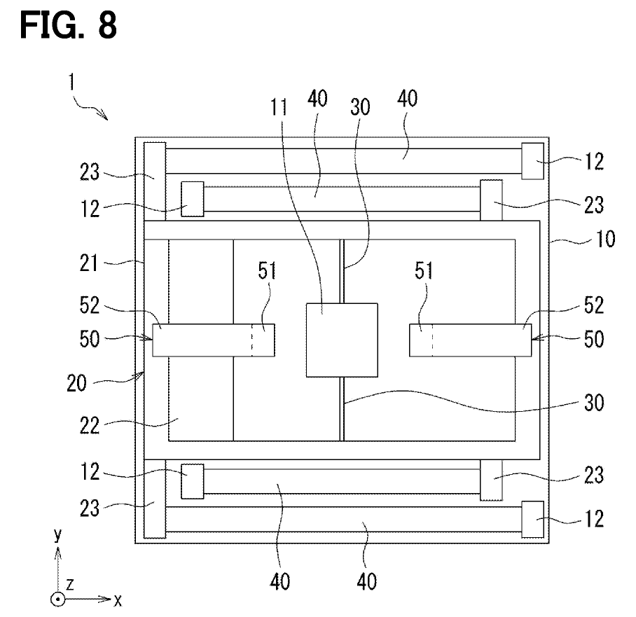

For example, as shown in FIG. 8, the accelerometer 1 may also be configured such that, in a top view, two sets of the second anchors 12, the connecting portions 23, and the leaf springs 40 are arranged on the opposite side across the inertial body 20, that is, on the upper side in the y-direction. In this case, for example, the accelerometer 1 is configured such that multiple sets of second anchors 12, connecting portions 23, and leaf springs 40 are arranged symmetrically around the inertial body 20.

With this modified example as well, the accelerometer 1 can achieve the same effects as those of the third embodiment described above. Furthermore, since multiple sets of second anchors 12, connecting portions 23, and leaf springs 40 are provided on both outer sides across the frame portion 21, the displacement of the inertial body 20 in the x- and y-directions is further suppressed, allowing detection of acceleration in the z-direction with lower noise.

### Other Embodiments

Although the present disclosure has been made in accordance with the embodiments, it is understood that the present disclosure is not limited to such embodiments and structures. The present disclosure encompasses various modifications and variations within the scope of equivalents. In addition, various combinations and modes, and other combinations and modes including only one element, more elements, or less elements are also within the scope and idea of the present disclosure.

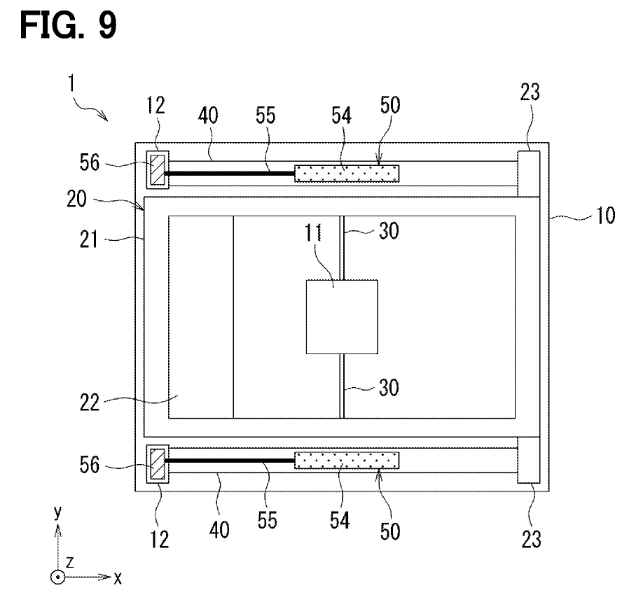

For example, in each of the embodiments described above, the accelerometer 1 employs an electrostatic method in which the detection electrode 50 detects the capacitance of the capacitor formed by the inertial body 20; however, the invention is not limited to this example, and it may alternatively be configured to detect the displacement of the inertial body 20 using a piezoelectric method. For example, as shown in FIG. 9, the detection electrode 50 of the accelerometer 1 may be configured by a piezoelectric element 54, a wiring 55 connected to the piezoelectric element 54, and an electrode section 56 that detects the charge generated by the piezoelectric element 54 via the wiring 55. The piezoelectric element 54 is located on the leaf spring 40, displaces together with the leaf spring 40, and generates a charge corresponding to the amount of displacement of the leaf spring 40. The wiring 55 is located, for example, on the leaf spring 40 and extends from the piezoelectric element 54 toward the second anchor 12. The electrode section 56 is located, for example, on the second anchor 12, and is connected to a wire (not shown), thereby enabling extraction of the charge generated in the piezoelectric element 54. In this case, the accelerometer 1 is configured such that a signal corresponding to the amount of displacement of the leaf spring 40—and thus the displacement of the inertial body 20—is output from the detection electrode 50, and acceleration is detected based on this signal.

Although FIG. 9 does not show a cross-sectional view, hatching is applied to the piezoelectric element 54 and the electrode section 56 to clarify the structure of the detection electrode 50. As described above, the detection method for the displacement of the inertial body 20 in the accelerometer 1 is not limited to the electrostatic method; a piezoelectric method may be used, or any other detection method such as an optical method may be employed. The structure and arrangement of the detection electrode 50 may also be appropriately modified.

In each of the embodiments described above, the accelerometer 1 may have a configuration in which, for example, polyimide or the like is applied to the leaf spring 40 in order to increase the damping coefficient. Furthermore, the accelerometer 1 only needs to have a configuration that includes the second anchor 12, the connecting portion 23, and the leaf spring 40, and is capable of suppressing the displacement of the inertial body 20 when the acceleration is applied in directions other than the z-direction; other components of the accelerometer may also be added as appropriate.

The constituent element(s) of each of the above embodiments is/are not necessarily essential unless it is specifically stated that the constituent element(s) is/are essential in the above embodiment, or unless the constituent element(s) is/are obviously essential in principle. Further, in each of the above embodiments, when the number, numerical values, quantities, ranges, or the like of the components of the embodiment are mentioned, such values are not limited to those specific numbers unless expressly indicated as essential or clearly limited to specific numbers in principle. Furthermore, a shape, positional relationship or the like of a structural element, which is referred to in the embodiments described above, is not limited to such a shape, positional relationship or the like, unless it is specifically described or obviously necessary to be limited in principle.

What is claimed is:

1. An accelerometer comprising:
a substrate;
an inertial body having a frame shape and suspended relative to the substrate;
at least one first anchor fixed to the substrate, the at least one first anchor located within a region of the substrate surrounded by the inertial body;
at least one set of torsion springs suspended relative to the substrate, the at least one set of torsion springs connecting the inertial body to the at least one first anchor;
at least one second anchor fixed to the substrate, the at least one second anchor being located at a position on the substrate different from a position of the first anchor; and
at least one leaf spring suspended relative to the substrate, the at least one leaf spring extending along an outer contour of the inertial body and extending in an extending direction orthogonal to the at least one set of torsion springs, the at least one leaf spring connecting the at least one second anchor to the inertial body, wherein
the at least one set of torsion springs are located on a common straight line, the straight line being an imaginary line,
a center of the at least one leaf spring in the extending direction is located on the common straight line, and
a center of gravity of the inertial body is offset with respect to positions of the at least one set of torsion springs.

2. The accelerometer according to claim 1, wherein
the at least one second anchor and the at least one leaf spring are located at the region of the substrate surrounded by the inertial body.

3. The accelerometer according to claim 1, wherein
the at least one second anchor is located outside the region of the substrate surrounded by the inertial body, and
the at least one leaf spring is connected to a connecting portion that extends outward from the outer contour of the inertial body.

4. The accelerometer according to claim 3, wherein
the at least one second anchor is one of a plurality of second anchors, and
the at least one leaf spring is one of a plurality of leaf springs.

5. The accelerometer according to claim 4, wherein
the plurality of second anchors and the plurality of leaf springs are located on both outer sides of the inertial body.
